(19) United States
(12) Patent Application Publication
(10) Pub. No.: US 2008/0184251 A1
(43) Pub. Date: Jul. 31, 2008

(54) SYSTEM AND METHOD FOR DOCUMENT PROCESSING QUOTA MANAGEMENT

(76) Inventors: Amir Shahindoust, Laguna Niguel, CA (US); Sameer Yami, Irvine, CA (US); Peter Tran, Garden Grove, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/669,801

(22) Filed: Jan. 31, 2007

(51) Int. Cl. G06F 9/50

(52) U.S. Cl. 718/104

(57) ABSTRACT

The subject application is directed to a system and method for document processing device resource management. Resource utilization data representing resources used in connection with each document processing operation is first received. The received resource utilization data is then stored. Statistical utilization data is then calculated in accordance with the stored resource utilization data. The statistical utilization data that has been calculated is then output to an associated administrator. Selection data, corresponding to resource quota data, is then received from the associated administrator. Resource quotas of an associated document processing device are then set in accordance with the received selection data.

### BACKGROUND OF THE INVENTION

The subject application is directed to a system and method for document processing resource management. More particularly, the subject application is directed to a system and method for automatically and adaptively collecting and analyzing system resource allocation data.

The resources, such as toner, paper, and the like, of a document processing device, such as a multifunctional peripheral device, must be monitored to ensure that each user, department, or other entity, does not exceed its allotted usage of a particular resource. Careful monitoring of resource usage relative to quotas provides assurances against waste or unauthorized usage of resources. It allows for monitoring of work output or activity of individual users or groups. Additionally, such information allows for budgeting or procurement of consumables, such as paper, toner, ink, transparencies, phone usage, connectivity time, electronic mail traffic, and the like.

Typically, a resource quota or limit is established by a system administrator such that when a resource meets the specified quota, a notification is generated and sent to an administrator that a user, department or entity has exceeded its quota. If the system administrator sets the quota too low, it will limit system performance as a user will likely not be able to perform many jobs without exceeding the quota. If the system administrator sets the quota too high, it will be difficult to detect if a user is using a particular resource in a manner that is not considered normal usage. However, each business has resource needs that are relatively unique. For example, users, such as law firms, will generally use a large amount of sheet stock, such as paper, while most printing will be in black and white. Other users, such as advertising agencies, may use less paper, but use a significant amount of color processing resources. In corporate environments, resource quotas may vary significantly among various departments, making it difficult for a system administrator to understand particular resource needs and set quotas accordingly. In addition, resource use for one or more machines may be altered over time, such as when new document processing needs become more ubiquitous in a particular group, or when a group evolves into increased staffing, work level, work type, or the like.

### SUMMARY OF THE INVENTION

In accordance with one embodiment of the subject application, there is provided a system and method for document processing resource management.

Further, in accordance with one embodiment of the subject application, there is provided a system and method for automatically and adaptively collecting and analyzing system resource allocation data.

Still further, in accordance with one embodiment of the subject application, there is provided a system for document processing resource management. The system comprises means adapted for receiving resource utilization data representative of resources used in connection with each of a plurality of document processing operations, storage means adapted for storing received resource utilization data, and calculation means adapted for calculating statistical utilization data in accordance with stored resource utilization data. The system further comprises means adapted for outputting statistical utilization data to an associated administrator, means adapted for receiving selection data corresponding to resource quota data form the associated administrator, and means adapted for setting resource quotas of an associated document processing device in accordance with received selection data.

In one embodiment of the subject application, the system further comprises statistical testing means adapted for testing statistical utilization data relative to a normal distribution value and means adapted for generating suggested values for selection data in accordance with an output of the testing means.

In another embodiment of the subject application, the suggested values are generated in accordance with a mean plus 3 standard deviations relative to resource usage data.

In a further embodiment of the subject application, the system also comprises quota testing means adapted for testing received resource utilization data against set resource data and means adapted for generating a notification signal in accordance with an output of the quota testing means.

In yet another embodiment, the system also comprises means adapted for selectively clearing the storage means such that calculation of statistical utilization data is recommenced.

Still further, in accordance with one embodiment of the subject application, there is provided a method for document processing resource management in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for document processing resource management according to one embodiment of the subject application;

FIG. 2 is a block diagram illustrating controller hardware for use in the system for document processing resource management according to one embodiment of the subject application;

FIG. 3 is a functional diagram illustrating the controller for use in the system for document processing resource management according to one embodiment of the subject application;

FIG. 4 is a block diagram illustrating device hardware for use in the system for document processing resource management according to one embodiment of the subject application;

FIG. 5 is a functional diagram illustrating the device for use in the system for document processing resource management according to one embodiment of the subject application;

FIG. 6 is a block diagram illustrating a server for use in the system for document processing resource management according to one embodiment of the subject application;

FIG. 7 is a flowchart illustrating a method for document processing resource management according to one embodiment of the subject application; and

FIG. 8 is a flowchart illustrating a method for document processing resource management according to one embodiment of the subject application.

### DETAILED DESCRIPTION OF THE PREFERRED EMBODIMENT

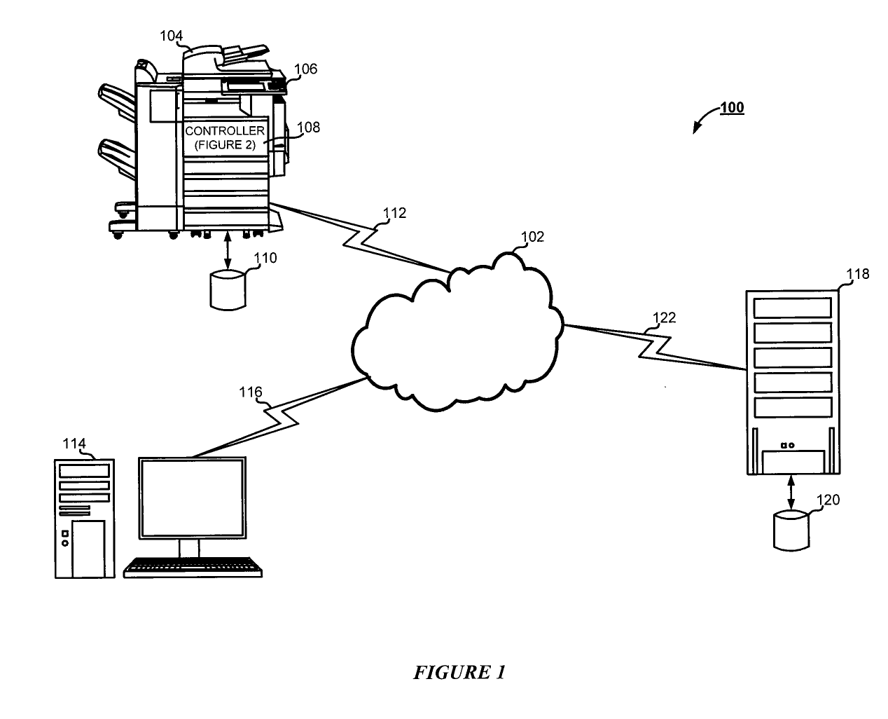

The subject application is directed to a system and method for document processing resource management. In particular, one embodiment of the subject application is directed to a system and method for automatically and adaptively collecting and analyzing system resource allocation data. It will become apparent to those skilled in the art that the system and method described herein are suitably adapted to a plurality of varying electronic fields employing resource management, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for document processing resource management in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

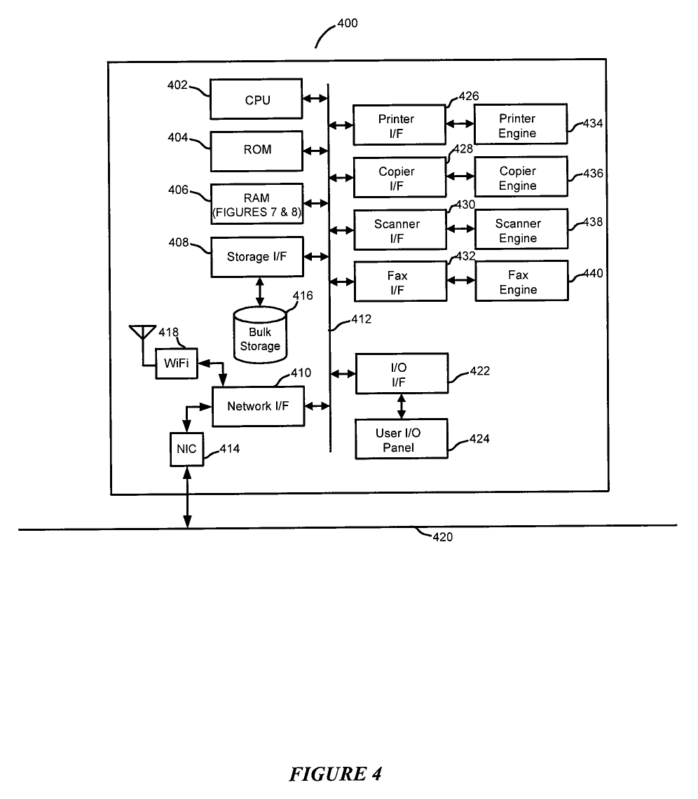

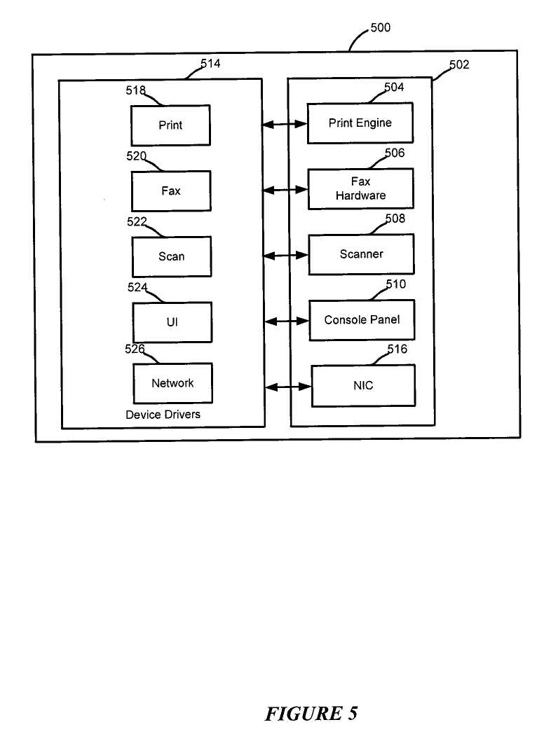

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The operation of the document processing device 104 will better be understood in conjunction with the block diagram illustrated in FIG. 4 and FIG. 5, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

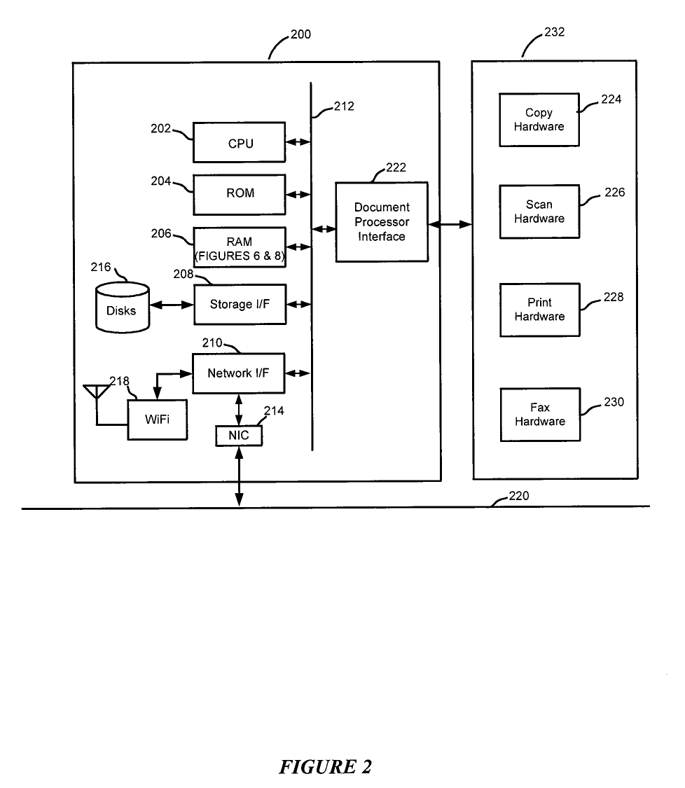

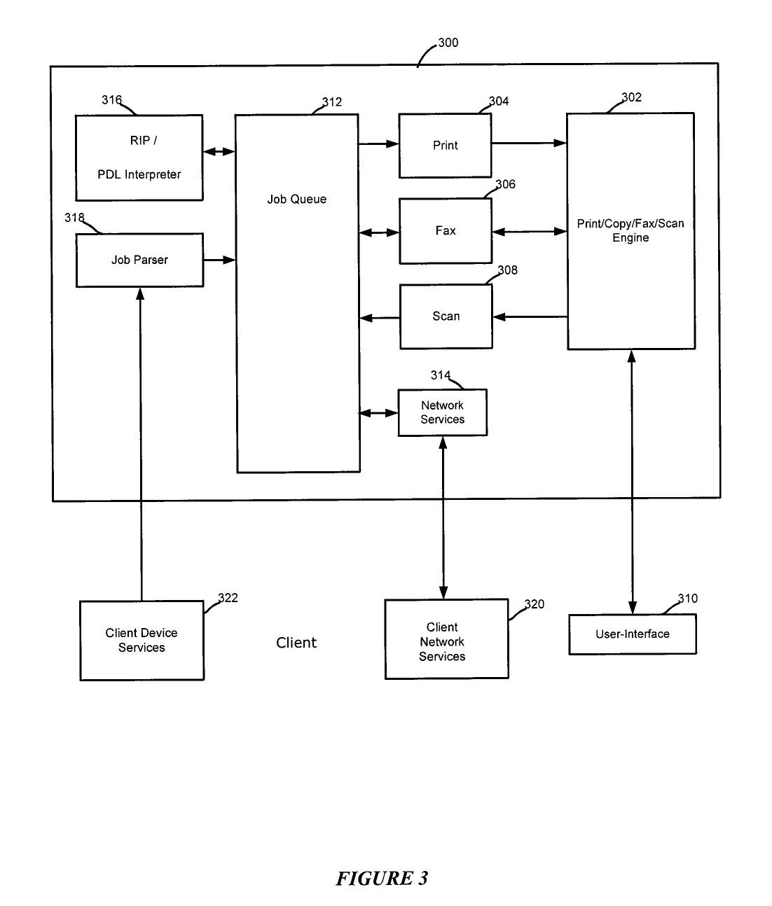

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for document processing resource management of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like. In accordance with one embodiment of the subject application, the data storage device 110 is suitably adapted to store electronic data representing document processing resource usage corresponding to the associated document processing device 104, quotas, usage data, and the like.

The system 100 illustrated in FIG. 1 further depicts an administrative device 114, in data communication with the computer network 102 via a communications link 116. It will be appreciated by those skilled in the art that the administrative device 114 is shown in FIG. 1 as a personal computer for illustration purposes only. As will be understood by those skilled in the art, the administrative device 114 is representative of any personal computing device known in the art, including, for example and without limitation, a computer workstation, a laptop computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the administrative device 114 is suitably adapted to received resource utilization data from a variety of sources, calculate appropriate levels of resources for allocation, and the like. It will be understood by those skilled in the art that the administrative device 114 is further capable of displaying utilization data to an associated administrator, via a suitable interface, receive management selections from the associated administrator, and communicate the same to an appropriate backend component associated with resource management on the computer network 102.

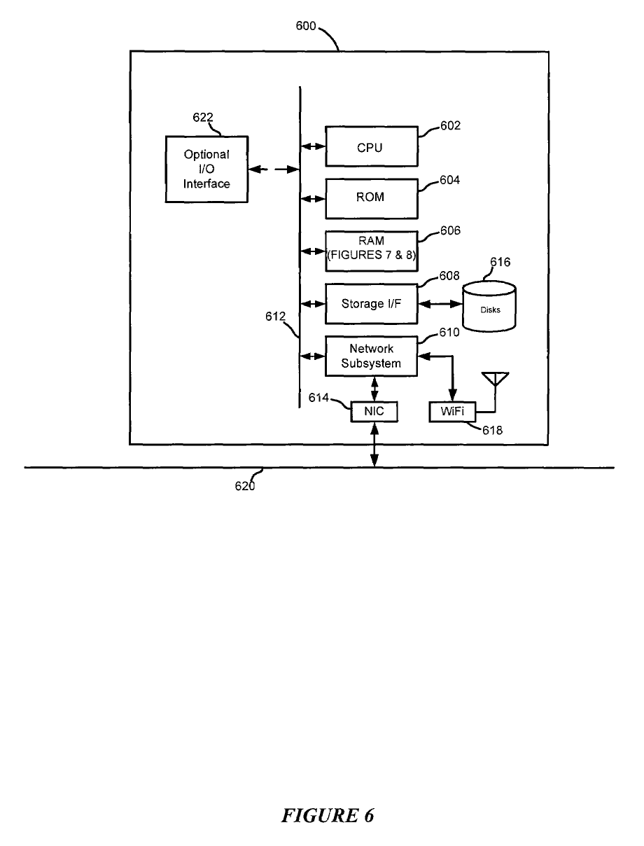

The system 100 of FIG. 1 further includes a resource server 118, coupled to a data storage device 120. Preferably, the resource server 118 is representative of any computing device known in the art capable of storing document data, resource utilization data, device identification data, resource management applications, image data, video data, sound data, multimedia data, or other suitable electronic data, as will be known in the art. In accordance with one embodiment of the subject application, the data storage device 120 includes a plurality of electronic data, including document processing data, resource usage data, document processing device data, image data, document data, or the like. In accordance with one embodiment of the subject application, the data storage device 120 is any mass storage device known in the art including, for example and without limitation, magnetic storage drives, a hard disk drive, optical storage devices, flash memory devices, or any suitable combination thereof. The resource server 118 is communicatively coupled to the computer network 102 via a suitable communications link 122. As will be understood by those skilled in the art, the communications link 122 includes, for example and without limitation a proprietary communications network, infrared, optical, Bluetooth, WiMax, 802.11a, 802.11b, 802.11g, 802.11(x), the public switched telephone network, or any suitable wireless data transmission system, or wired communications known in the art. The operation of the resource server 118 will be better understood in conjunction with the block diagram illustrated in FIG. 6, explained in greater detail below.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image processor, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

Turning now to FIG. 4, (shown in FIG. 1 as the document processing device 104) illustrated is a representative architecture of a suitable device 400 on which operations of the subject system are completed. Included is a processor 402, suitably comprised of a central processor unit. However, it will be appreciated that the processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by the processor 402.

A storage interface 408 suitably provides a mechanism for volatile, bulk or long term storage of data associated with the device 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the device 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 414 is interconnected for data interchange via a physical network 420, suitably comprised of a local area network, wide area network, or a combination thereof.

Data communication between the processor 402, read only memory 404, random access memory 406, storage interface 408 and the network subsystem 410 is suitably accomplished via a bus data transfer mechanism, such as illustrated by bus 412.

Suitable executable instructions on the device 400 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 422 to a user input/output panel 424 as will be appreciated by one of ordinary skill in the art.

Also in data communication with bus 412 are interfaces to one or more document processing engines. In the illustrated embodiment, printer interface 426, copier interface 428, scanner interface 430, and facsimile interface 432 facilitate communication with printer engine 434, copier engine 436, scanner engine 238, and facsimile engine 440, respectively. It is to be appreciated that the device 400 suitably accomplishes one or more document processing functions. Systems accomplishing more than one document processing operation are commonly referred to as multifunction peripherals or multifunction devices.

Turning now to FIG. 5, illustrated is a suitable document processing device for use in connection with the disclosed system. FIG. 5 illustrates suitable functionality of the hardware of FIG. 4 in connection with software and operating system functionality as will be appreciated by one of ordinary skill in the art. The document processing device 500 suitably includes an engine 502 which facilitates one or more document processing operations.

The document processing engine 502 suitably includes a print engine 504, facsimile engine 506, scanner engine 508 and console panel 510. The print engine 504 allows for output of physical documents representative of an electronic document communicated to the processing device 500. The facsimile engine 506 suitably communicates to or from external facsimile devices via a device, such as a fax modem.

The scanner engine 508 suitably functions to receive hard copy documents and in turn image data corresponding thereto. A suitable user interface, such as the console panel 510, suitably allows for input of instructions and display of information to an associated user. It will be appreciated that the scanner engine 508 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 5, the document processing engine also comprises an interface 516 with a network via driver 526, suitably comprised of a network interface card. It will be appreciated that a network thoroughly accomplishes that interchange via any suitable physical and non-physical layer, such as wired, wireless, or optical data communication.

The document processing engine 502 is suitably in data communication with one or more device drivers 514, which device drivers allow for data interchange from the document processing engine 502 to one or more physical devices to accomplish the actual document processing operations. Such document processing operations include one or more of printing via driver 518, facsimile communication via driver 520, scanning via driver 522 and a user interface functions via driver 524. It will be appreciated that these various devices are integrated with one or more corresponding engines associated with the document processing engine 502. It is to be appreciated that any set or subset of document processing operations are contemplated herein. Document processors which include a plurality of available document processing options are referred to as multi-function peripherals.

Turning now to FIG. 6, illustrated is a representative architecture of a suitable server 600 (illustrated in FIG. 1 as the resource server 118) on which operations of the subject system are completed. Included is a processor 602, suitably comprised of a central processor unit. However, it will be appreciated that the processor 602 may advantageously be composed of multiple processors working in concert with one another as will be appreciated by one of ordinary skill in the art. Also included is a non-volatile or read only memory 604 which is advantageously used for static or fixed data or instructions, such as BIOS functions, system functions, system configuration, and other routines or data used for operation of the server 600.

Also included in the server 600 is random access memory 606, suitably formed of dynamic random access memory, static random access memory, or any other suitable, addressable memory system. Random access memory provides a storage area for data instructions associated with applications and data handling accomplished by the processor 602.

A storage interface 608 suitably provides a mechanism for volatile, bulk or long term storage of data associated with the server 600. The storage interface 608 suitably uses bulk storage, such as any suitable addressable or serial storage, such as a disk, optical, tape drive and the like as shown as 616, as well as any suitable storage medium as will be appreciated by one of ordinary skill in the art.

A network interface subsystem 610 suitably routes input and output from an associated network allowing the server 600 to communicate to other devices. The network interface subsystem 610 suitably interfaces with one or more connections with external devices to the server 600. By way of example, illustrated is at least one network interface card 614 for data communication with fixed or wired networks, such as Ethernet, token ring, and the like, and a wireless interface 618, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 614 is interconnected for data interchange via a physical network 620, suitably comprised of a local area network, wide area network, or a combination thereof.

Data communication between the processor 602, read only memory 604, random access memory 606, storage interface 608 and the network subsystem 610 is suitably accomplished via a bus data transfer mechanism, such as illustrated by bus 612.

Suitable executable instructions on the server 600 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 622 as will be appreciated by one of ordinary skill in the art.

In operation, resource utilization data representing resources used in connection with each document processing operation is first received. The received resource utilization data is then stored. Statistical utilization data is then calculated in accordance with the stored resource utilization data. The statistical utilization data that has been calculated is then output to an associated administrator. Selection data, corresponding to resource quota data, is then received from the associated administrator. Resource quotas of an associated document processing device are then set in accordance with the received selection data.

In accordance with one example embodiment of the subject application, resource utilization data is first received corresponding to resources used in connection with each document processing operation associated with the document processing device 104. Suitable resource utilization data includes, for example and without limitation, toner usage, output media usage, processing usage, time, data storage capacity usage, and the like. The skilled artisan will appreciate that each document processing operation capable of being performed by the associated document processing device 104 will have varying resource usage requirements. For example and without limitation, copy operations use toner, output media and processing time, whereas scanning operations use processing time and storage capacity. Thus, the skilled artisan will appreciate that other document processing operations, capable of performance by the associated document processing device 104, require various resources and the subject application is applicable to each such operation.

The resource utilization data is then tested against set resource, or quota, data. Preferably, the quota data is representative of a limit on at least one of the resources associated with the document processing device 104. It will be appreciated by those skilled in the art that the testing is capable of being performed by the controller 108 associated with the document processing device 104, by the administrative device 114 during periodic reviews of usage data, by the resource server 118, or the like. Preferably, the controller 108, or other suitable backend component associated with the document processing device 104 performs the testing, by comparing the received resource utilization data against administratively set usage quotas. A determination is then made based upon the outcome of the comparison and when the received resource data is at or within a predetermined proximity to any one of the quotas associated with the document processing device 104, a particular user, department, or the like, a notification signal is generated and forwarded to an appropriate administrator, services provider, owner, department head, or the like.

When the controller 108, or other suitable component as set forth above, determines that the quota has not been reached, a determination is made whether to clear previously stored resource data, so as to enable the recommencing of statistical utilization calculation to proceed. That is, the controller 108, or other suitable component as set forth above, determines whether or not clear previously stored quota data to calculate a new quota. The skilled artisan will appreciate that such an occurrence is capable being initiated by the elapse of a predetermined period of time, a number of document processing operations, the request of an administrator, or the like. When no such instruction, i.e., no instruction to clear the previously stored data, the operation terminates. When a determination is made to clear the storage of previous data, the storage device, i.e., storage device 110, a local storage to the administrative device 114, or the data storage device 120, is cleared.

The resource utilization data is then stored in an appropriate storage location. Thus, when the system 100 employs the resource server 118 for resource management purposes, the resource utilization data is uploaded to the resource server 118 via the computer network 102, and stored in the associated data storage device 120. Similarly, when the system 100 employs the administrative device 114 only, the data is uploaded to the administrative device 114 and stored locally, via an associated hard disk drive, magnetic, optical storage, or the like. In addition, the controller 108 of the associated document processing device 104 is capable of directing the storage of the resource utilization data on the data storage device 110, as will be appreciated by those skilled in the art.

Statistical utilization data is then calculated based upon the received resource utilization data. It will be appreciated by those skilled in the art that the calculated statistical utilization data is capable of being used to advise an associated administrator in the setting of quotas associated with a given document processing device 104. Thus, the calculated statistical utilization data is output to an associated administrator via any suitable means. In accordance with one embodiment, the data is output by the controller 108 to the user interface 106, thereby enabling the administrator to view the data directly at the document processing device 104. According to another embodiment, the data is output, via the computer network 102, to the resource server 118, whereupon an administrator associated therewith, is able to view the data via an associated user interface. In accordance with another embodiment of the subject application, the data is output, via the computer network 102, to the administrative device 114, whereupon the administrator is able to view the data.

The statistical data is then tested relative to a normal distribution value by the receiving device, i.e., the controller 108, the administrative device 114, or the resource server 118, to generate a suggested value for selection by the administrator. That is, the statistical data, representing usage over a period of time, is analyzed by the receiving device with respect to a normal distribution value to generate a suggested quota for application to the document processing device 104. It will be understood by those skilled in the art that the normal distribution value is capable of including, for example and without limitation, a mean plus three (3) standard deviations relative to resource usage data. The skilled artisan will appreciate that other methods of determining a normal distribution value are capable of being employed in accordance with the subject application, without departing from the scope thereof. That is, the skilled artisan will appreciate that normal resource usage data is capable of being used, as gathered from a group of similar document processing devices (not shown), preset manufacturing data, or the like, using a mean plus three (3) standard deviations.

The suggested value, as generated, is then presented to the administrator via a suitable graphical user interface associated with the device (controller 108, administrative device 114, server 118) through which the resource data is currently being accessed. The administrator is thereby prompted to input a new or modified resource quota associated with the document processing device 104. This data is then received by the controller 108 via the computer network 102, when originating from the administrative device 114 or resource server 118, or from the user interface 106. Resource quotas associated with the document processing device 104 are then set in accordance with the received selection data. Stated another way, the document processing device 104, via the controller 108, then sets resource usage limits on users, groups of users, types of operations, types of output media, processing time, and the like, corresponding to the receiving document processing device 104.

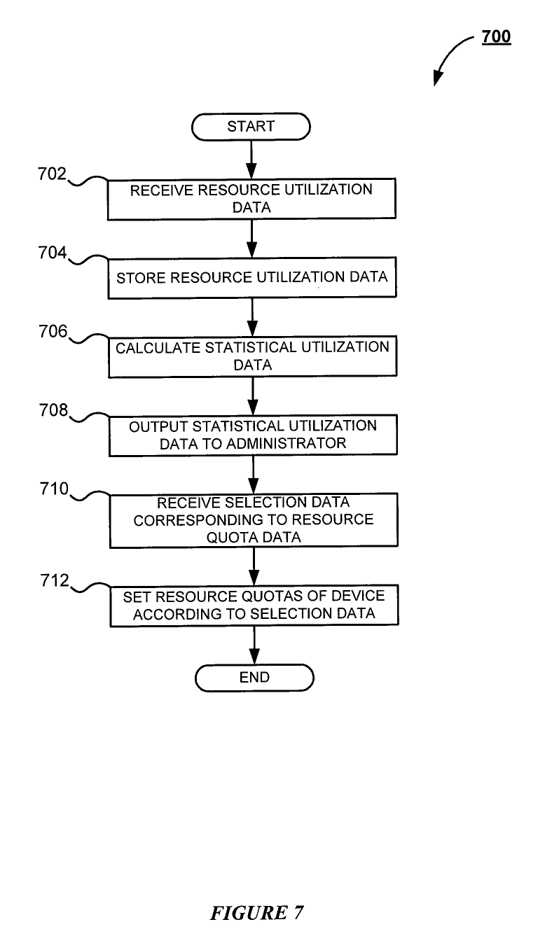

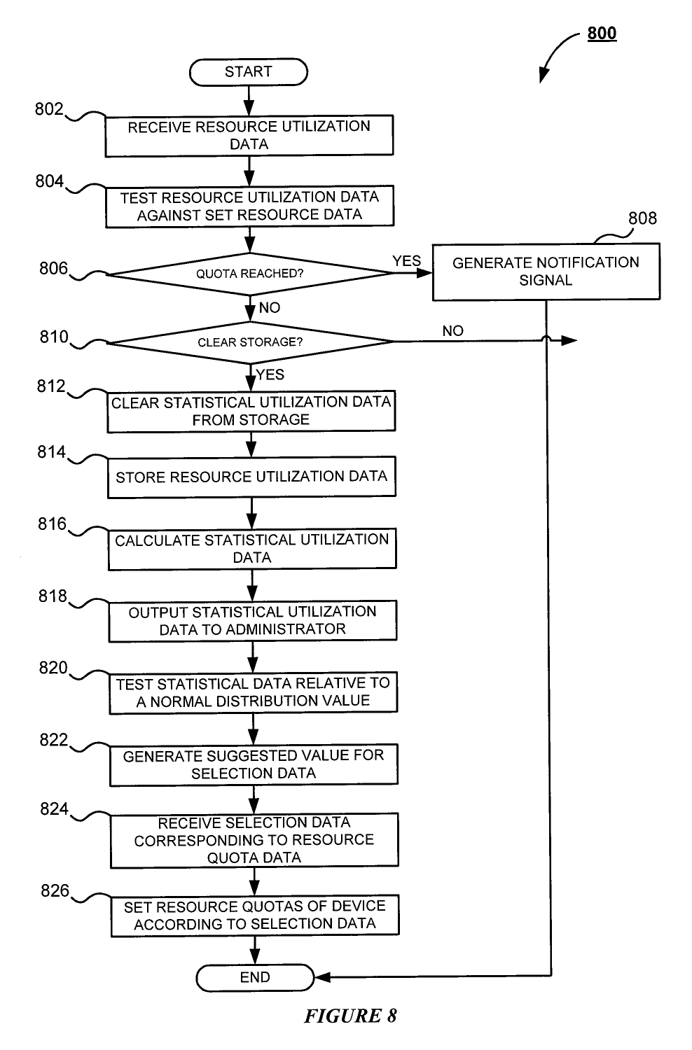

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for document processing device resource management in accordance with one embodiment of the subject application. Beginning at step 702, resource utilization data representing resources used in connection with each of a plurality of document processing operations is received. Preferably, this data is collected by the document processing device 104, via the controller 108, and communicated via the computer network 102 to the resource management server 118. It will be understood by those skilled in the art that in accordance with one embodiment of the subject application, the resource utilization data is capable of being received directly by the administrative device 114, thereby obviating the need for the resource management server 118. The skilled artisan will further appreciate that the subject application is further capable of a myriad of implementations, and the use of the system 100 is for example purposes only.

At step 704, the resource utilization data is stored at the receiving device. For example, when the system 100 employs the resource management server 118, the resource utilization data is suitably stored in the data storage device 120. In a further example, when the system 100 employs the administrative device 114, the resource data is stored locally, via a hard disk drive or the like. In accordance with a further embodiment of the subject application, the resource utilization data is stored via the data storage device 110 of the document processing device 104. Statistical utilization data is then calculated at step 706 in accordance with the stored resource utilization data. The skilled artisan will appreciate that the calculation is capable of being accomplished via the controller 108, the administrative device 114, the resource server 118, or the like.

The statistical utilization data is then output to an associated administrator at step 708. Preferably, the statistical utilization data is output to the administrator via a suitable graphical user interface, thereby enabling the administrator to view the statistical data. In accordance with one embodiment of the subject application, the statistical data is output from the storage, e.g., storage device 110, storage device 120, or internal hard drive, to the administrator, via the administrative device 114, the user interface 106 of the document processing device 104, or a user interface associated with the resource server 118. At step 710, selection data corresponding to resource quota data is received from the administrator. Preferably, the administrator selects suitable quota data based upon statistical toner usage, storage capacity usage, output media usage, processing times, or the like. In accordance with one embodiment of the subject application, the selection data is received via a suitable graphical user interface, via which the administrator is capable of selecting desired quota limits based upon the calculated statistical utilization data. At step 712, the resource quotas of the associated document processing device 104 are set based upon the quota selection data. In accordance with one embodiment of the subject application, the document processing device 104 receives the set data via the computer network 102 from the resource server 118, the administrative device 114, or the user interface 106. Thereafter, the controller 108 stores the set data via the storage device 110, whereupon the controller 108 then monitors usage data in accordance with the set quotas.

Referring now to FIG. 8, there is shown a flowchart 800 illustrating a method for document processing device resource management in accordance with one embodiment of the subject application. The method begins at step 802, whereupon resource utilization data is first received representing resources used in connection with each of a plurality of document processing operations. It will be understood by those skilled in the art that suitable resource utilization data includes, for example and without limitation, toner usage, output media usage, processing usage, time, data storage capacity usage, and the like. It will also be apparent to one skilled in the art that each document processing operation capable of being performed by the associated document processing device 104 will have varying resource usage requirements. For example and without limitation, copy and print operations use toner, output media and processing time, whereas scanning and electronic mail operations use processing time and storage capacity.

The resource utilization data that has been received is then tested at step 804 against set resource data, or resource quotas. That is, the document processing device 104, via the controller 108 or other suitable backend component, retrieves set quotas from storage, i.e., storage device 110, and compares the received utilization data against those retrieved quotas. In the event that the quota has been reached, as determined at step 806, a notification signal is generated at step 808 and transmitted to the administrator indicating that a user, group of users, company, department, or the like, has reached or is near the resource limits set by the administrator with respect to the document processing device 104.

When it is determined at step 806 that the quota, or quotas, has not been met, flow proceeds to step 810, whereupon a determination is made whether to clear data storage of previously set quotas. That is, a determination is made whether to proceed with calculating a new or modified quota for the document processing device 104, or to allow the current quota to remain. When the current quota remains, the operation terminates, as no modification to the existing quota is necessitated. When the storage is to be cleared, i.e., an administrator manually determines to reset the quotas, the quotas have exceeded a predetermined period of time, or the like, flow proceeds to step 812, whereupon the quotas are cleared from storage.

The received resource utilization data is stored in an associated storage at step 814. It will be appreciated by those skilled in the art that when the system 100 employs the resource management server 118, the utilization data is suitably stored on the data storage device 120. Similarly, when the system employs the administrative device 114 and no corresponding server, the data is stored on an associated data storage, such as a hard disk drive, optical storage device, or the like. In accordance with one particular embodiment of the subject application, a stand alone document processing device 104, i.e., one that is not connected to the computer network 102, or one that is not connected to a suitable server 118 or administrative device 114, is capable of storing the data via the data storage device 110.

Once the data has been stored at step 814, flow proceeds to step 816, whereupon statistical utilization data is calculated in accordance with the received resource utilization data. It will be appreciated by those skilled in the art that the calculations referenced in step 816 are capable of being carried out by the controller 108 associated with the document processing device 104, the administrative device 114, or the resource server 118. Once the statistical data has been calculated, flow progresses to step 818, whereupon the statistical utilization data is output to an associated administrator. It will be understood by those skilled in the art that the output to the administrator will depend upon the location of the administrator, i.e., whether the administrator is associated with the resource server 118, the administrative device 114, or physically proximate to the user interface 106 of the document processing device 104. For example, when the administrator is associated with the resource server 118, the data is output, via the computer network 102, to the resource server 118, whereupon an administrator associated therewith, is able to view the data via an associated graphical user interface. When the administrator is associated with the administrative device 114, the data is output, via the computer network 102, to the administrative device 114, whereupon the administrator is able to view the data via a graphical user interface associated therewith. In an additional example, the administrator is accessing the document processing device 104 via the associated user interface 106, thus the data is output by the controller 108 to the user interface 106, thereby enabling the administrator to view the data directly at the document processing device 104.

The statistical data is then tested, at step 820, relative to a normal distribution value by the device that has received and/or calculated the statistical resource usage data. That is, the controller 108, the administrative device 114, or the resource server 118, tests the statistical data relative to a normal distribution value. Thus, the calculated statistical resource data, representing resource usage over a period of time, is analyzed with respect to a normal distribution value to generate a suggested quota for application to the document processing device 104. In accordance with one embodiment of the subject application, the normal distribution value is capable of including, for example and without limitation, a mean plus three (3) standard deviations relative to resource usage data. It will be appreciated by those skilled in the art that normal resource usage data is capable of being used, as gathered from a group of similar document processing devices (not shown), preset manufacturing data, or the like, using a mean plus three (3) standard deviations. Other methods of determining a normal distribution value, as will be known in the art, are capable of being employed in accordance with the subject application, without departing from the scope thereof.

A suggested value for the new or modified quota is then generated at step 822 based upon the outcome of the test at step 820. The suggested value, as generated, is then presented to the administrator via a suitable graphical user interface associated with the device (controller 108, administrative device 114, resource server 118) through which the resource data is currently being accessed. The administrator is thereby prompted to input a new or modified resource quota associated with the document processing device 104. This data is then received at step 824 by the controller 108 from the user interface 106, or via the computer network 102, when originating from the administrative device 114 or resource server 118. Resource quotas associated with the document processing device 104 are then set at step 826 in accordance with the received selection data. Stated another way, the document processing device 104, via the controller 108, then sets resource usage limits on users, groups of users, types of operations, types of output media, processing time, and the like, corresponding to the receiving document processing device 104.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A document processing device resource management system comprising:
means adapted for receiving resource utilization data representative of resources used in connection with each of a plurality of document processing operations;
storage means adapted for storing received resource utilization data;
calculation means adapted for calculating statistical utilization data in accordance with stored resource utilization data;
means adapted for outputting statistical utilization data to an associated administrator;
means adapted for receiving selection data corresponding to resource quota data from the associated administrator; and
means adapted for setting resource quotas of an associated document processing device in accordance with received selection data.

2. The document processing device resource management system of claim 1 comprising:
statistical testing means adapted for testing statistical utilization data relative to a normal distribution value; and
means adapted for generating suggested values for selection data in accordance with an output of the testing means.

3. The document processing device resource management system of claim 2 wherein the suggested values are generated in accordance with a mean plus 3 standard deviations relative to resource usage data.

4. The document processing device resource management system of claim 1 comprising:
quota testing means adapted for testing received resource utilization data against set resource data; and
means adapted for generating a notification signal in accordance with an output of the quota testing means.

5. The document processing device resource management system of claim 4 comprising means adapted for selectively clearing the storage means such that calculation of statistical utilization data is recommenced.

6. A document processing device resource management method comprising the steps of:
receiving resource utilization data representative of resources used in connection with each of a plurality of document processing operations;
storing received resource utilization data;
calculating statistical utilization data in accordance with stored resource utilization data;
outputting statistical utilization data to an associated administrator;
receiving selection data corresponding to resource quota data from the associated administrator; and
setting resource quotas of an associated document processing device in accordance with received selection data.

7. The document processing device resource management method of claim 6 comprising the steps:
testing statistical utilization data relative to a normal distribution value; and
generating suggested values for selection data in accordance with an output of the testing.

8. The document processing device resource management method of claim 7 wherein the suggested values are generated in accordance with a mean plus 3 standard deviations relative to resource usage data.

9. The document processing device resource management method of claim 8 comprising the steps:
testing received resource utilization data against set resource data; and
generating a notification signal in accordance with an output of the quota testing.

10. The document processing device resource management method of claim 9 comprising the step of selectively clearing the storage such that calculation of statistical utilization data is recommenced.

11. A computer-implemented method for document processing device resource management comprising the steps of:
receiving resource utilization data representative of resources used in connection with each of a plurality of document processing operations;
storing received resource utilization data;
calculating statistical utilization data in accordance with stored resource utilization data;
outputting statistical utilization data to an associated administrator;
receiving selection data corresponding to resource quota data from the associated administrator; and
setting resource quotas of an associated document processing device in accordance with received selection data.

12. The computer-implemented method for document processing device resource management of claim 11 comprising the steps:
testing statistical utilization data relative to a normal distribution value; and
generating suggested values for selection data in accordance with an output of the testing.

13. The computer-implemented method for document processing device resource management of claim 12 wherein the suggested values are generated in accordance with a mean plus 3 standard deviations relative to resource usage data.

14. The computer-implemented method for document processing device resource management of claim 13 comprising the steps:
testing received resource utilization data against set resource data; and
generating a notification signal in accordance with an output of the quota testing.

15. The computer-implemented document processing device resource management of claim 14 comprising the step of selectively clearing the storage such that calculation of statistical utilization data is recommenced.
